(19) United States
(12) Patent Application Publication
(10) Pub. No.: US 2007/0128485 A1
(43) Pub. Date: Jun. 7, 2007

(54) Fuel cell system

(75) Inventors: Ji-Cheng Zhao, Latham, NY (US); Ke Liu, Rancho Santa Margarita, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/292,584

(22) Filed: Dec. 2, 2005

(51) Int. Cl. H01M 8/04; H01M 8/10

(52) U.S. Cl. 429/26; 429/34; 429/30; 429/13

(57) ABSTRACT

A fuel cell system comprises a hydrogen storage system for storing and releasing hydrogen, a fuel cell in fluid communication with the hydrogen storage system for receiving released hydrogen from the hydrogen storage system and for electrochemically reacting the hydrogen with an oxidant to produce electricity and an anode exhaust. A catalytic combustor is in fluid communication with the fuel cell for receiving the anode exhaust and for catalytically reacting the anode exhaust to produce an offgas having an elevated temperature that is greater than the temperature of the anode exhaust. The heat from the offgas is used to release the hydrogen from the hydrogen storage system. An electrical heater is coupled to the catalytic combustor to enable cold start of the fuel cell and the storage system.

### CROSS REFERENCE TO RELATED APPLICATIONS

This application is related to U.S. patent application Ser. No. 11/193,970, entitled “A Fuel Cell System,” having a docket number 183593-1 and filed on Jul. 29, 2005, and to co-pending U.S. Patent Application No. ______, entitled “Fuel Cell System,” having a docket number 183593-2 and filed concurrently herewith, each of which are herein incorporated by reference.

### BACKGROUND

The invention relates generally to fuel cell systems and more specifically to catalytically combusting an anode exhaust of a fuel cell, for example a Proton Exchange Membrane (PEM) fuel cell, to provide the heat to release hydrogen from a storage material.

Fuel cells, for example PEM fuel cells, are touted as the future of the automotive industry. Fuel cells electrochemically react a fuel, such as hydrogen, with an oxidant, such as air, to produce electricity and water. PEM fuel cells are ideally suited for use in automobiles or for in-home applications.

In order for fuel cells to become practical for use within automobiles, a storage solution must be demonstrated that will provide the necessary quantities of hydrogen to the fuel cell. One of the most common fuel cell and storage combinations is a PEM fuel cell with a metal hydride storage tank. In this system, the metal hydride storage tank is heated and stored hydrogen is released to the PEM fuel cell for electricity generation. A metal hydride must reach a certain temperature before it can release hydrogen. A metal hydride storage system has good volumetric storage density when compared to liquefied and compressed hydrogen systems. Good volumetric storage density is especially important for on-board vehicular storage because it would allow adequate hydrogen storage without taking up valuable space on the vehicle.

Several metal hydrides are available commercially, representing a good solution for hydrogen storage where weight and volume are not a significant problem, for example on buses. For most vehicles, however, the problem with metal hydride storage is the high weight of the material compared to the amount of hydrogen that is stored. The problem of weight has still not been solved in spite of extensive research. Researchers are therefore trying to think in new directions, by trying to lighten the alloys or by improving the methods of packing the hydrogen in higher concentrations.

Work is being done to find cheaper metal alloys that have the ability to absorb large amounts of hydrogen and at the same time release the hydrogen at a relatively low temperature. The International Energy Agency's (IEA) metal hydride program has a goal of developing a material that has a reversible storage capacity of 5 weight percent absorbed hydrogen and hydrogen release at less than 100° C., within the next few years. The Department of Energy (DOE) has a goal of developing a material that has reversible storage capacity of 9 weight percent absorbed hydrogen and hydrogen release at less than 100° C. by 2015, still considered to be an extremely aggressive target. Today's modern PEM fuel cells operate at relatively low temperatures, typically at about 80° C. Typically, the excess heat from the fuel cell is used to release the hydrogen from the metal hydride storage tank. Accordingly, it is widely assumed that the most practical applications would require the metal hydride storage tank to release hydrogen at about the same temperature that the fuel cell operates at, for example with PEM fuel cells, this temperature range would be from about 60° C. to about 80° C., and widely assumed to be less than 100° C. It is widely believed that the energy efficiency of the system will be lower, and the system will be more complex, if extra heat must be independently generated to release the hydrogen from the tank.

Another challenge of the current hydrogen PEM fuel cell system is the difficulty in starting the system under cold weather conditions. It is necessary in cold climate regions to start a PEM fuel cell system in temperatures as low as −20° C. Currently, PEM fuel cell systems have not been developed that effectively resolve this issue with cold temperature starts.

Accordingly, there is a need to develop an improved fuel cell system that enables utilization of metal hydride storage tanks with higher hydrogen storage capacities without requiring independent heat generation to release the hydrogen from the metal hydride storage tanks. There is also a need to enable cold weather starts of a PEM fuel cell and a hydrogen storage system.

### BRIEF DESCRIPTION

A fuel cell system comprises a hydrogen storage system for storing and releasing hydrogen, a fuel cell in fluid communication with the hydrogen storage system for receiving released hydrogen from the hydrogen storage system and for electrochemically reacting the hydrogen with an oxidant to produce electricity and an anode exhaust. A catalytic combustor is in fluid communication with the fuel cell for receiving the anode exhaust and an oxidant for catalytically reacting the anode exhaust to produce an offgas having an elevated temperature that is greater than the temperature of the anode exhaust. The heat from the offgas is used to release the hydrogen from the hydrogen storage system. The system is further designed to enable cold start by bleeding hydrogen from the overpressure of the storage tank to the catalytic combustor to provide heat for desorption of hydrogen from the storage material.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of a conventional fuel cell system.

FIG. 2 is a schematic illustration of one embodiment of the instant invention.

FIG. 3 is another schematic illustration of one embodiment of the instant invention.

FIG. 4 is another schematic illustration of one embodiment of the instant invention.

### DETAILED DESCRIPTION

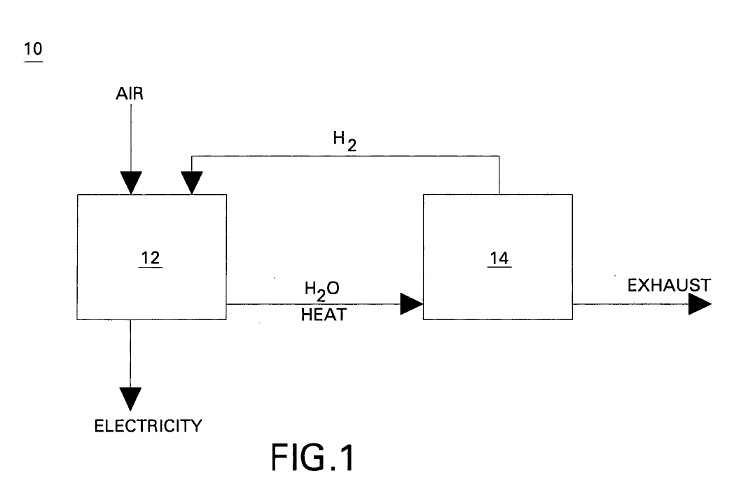

A conventional fuel cell system 10 comprising a fuel cell 12 and a metal hydride storage tank 14 is shown in FIG. 1. Typically, fuel cell 12 is a PEM fuel cell. As shown hydrogen (H₂) and air electrochemically react within fuel cell 12 to produce an exhaust. The exhaust is typically used to heat the metal hydride storage tank 14 to release the hydrogen for electrochemical reaction in the PEM fuel cell 12. The exhaust typically consists of water in the form of steam or moisture, nitrogen, and small quantities of hydrogen. After heating the hydrogen storage tank, the remaining exhausts vents outside of the system. Fuel cell system 10 is suited for many applications, especially for powering an automobile or other vehicles.

As discussed above, a significant challenge associated with implementing fuel cell system 10 into an automobile is the weight of the metal hydride storage tank required to provide sufficient hydrogen to the fuel cell to enable adequate travel distances, for example greater than about 250 miles. Accordingly, a significant amount of research is currently being conducted around identifying reversible metal hydride materials that have a much higher hydrogen storage capacity. One additional difficulty in dealing with these systems is the operating temperatures of the fuel cells. PEM fuel cells operate at about 80° C. There are two factors that limit PEM fuel cells from operating at higher temperatures: 1) the current PEM devices cannot withstand higher operating temperatures without system degradation; and 2) the PEM fuel cells need to be kept at a temperature below the boiling point of water to ensure the system is adequately hydrated. Accordingly, the current operating temperature limit of an ambient pressure PEM system is about 80° C. There are certain advantages to operate at higher temperatures, and for this reason, there are many efforts to develop higher temperature PEM systems. Future advancements of the PEM fuel cell might permit operating temperatures to push upwards to about 100° C.

In order to meet these dueling concerns, researchers have focused on developing high capacity storage materials that release hydrogen at a relatively low temperature, for example less than 100° C. Even if the operating temperature of PEM fuel cells rises to 100° C., it is still not high enough to release most of the hydrogen stored in high-capacity hydrides. For example, the best metal hydride storage solution that releases hydrogen at temperatures less than about 150° C. is currently NaAlH₄ with about 3.5 weight percent released at about 140° C. High capacity reversible metal hydride storage solutions for release at low temperatures are many years away. In fact, DOE has a goal of about 9% reversible storage capacity system, targeted at a release temperature of less than 100° C. in the year 2015. If either the weight limitations or the temperature restrictions were lifted, the implementation of these devices would surely accelerate.

Current metal hydride storage solutions exist that have a reversible storage capacity of greater than 7.5 wt. %, for example, 2LiBH₄+MgH₂, with a current capacity of about 10 wt % of H₂. The release temperature for this material, about 350-400° C., however, is significantly higher than the operating temperature of PEM fuel cells. For this reason, most of these higher capacity materials have not been researched for use in PEM operated vehicles or other fuel cell applications.

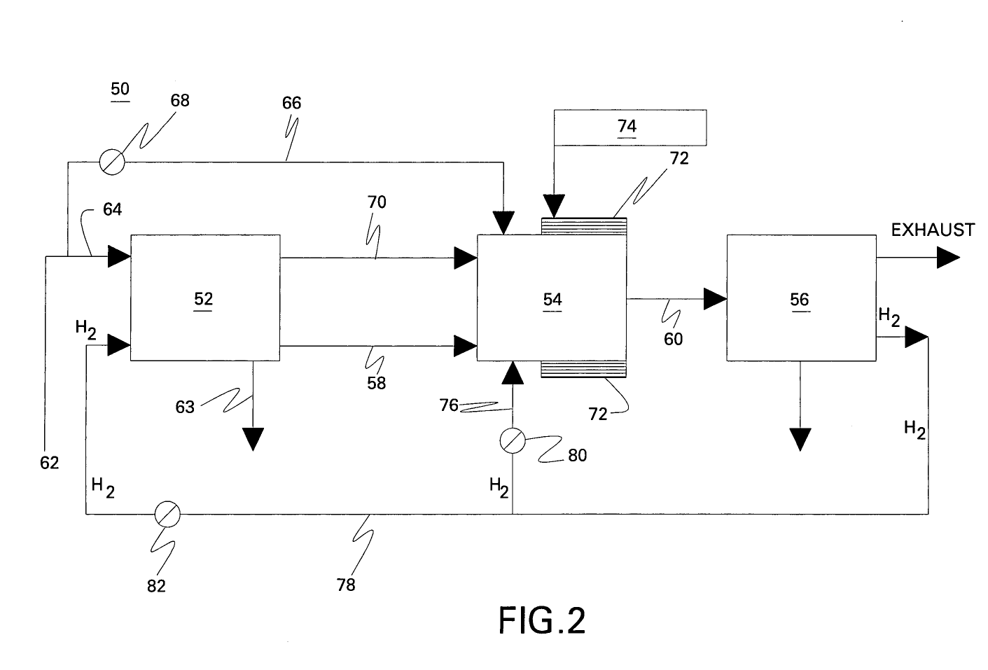

In accordance with one embodiment of the instant invention, a fuel cell system 50 is shown in FIG. 2. Fuel cell system 50 comprises a fuel cell 52, a catalytic combustor 54 and a hydrogen storage system 56. As will be discussed in greater detail below, fuel cell system 50 significantly advances the art of fuel cell systems using hydrogen storage tanks, especially metal hydride storage tanks. The anode exhaust 58 from the fuel cell 52 is combusted in catalytic combustor 54 to produce an offgas 60 with a temperature greater than about 150° C., and typically greater than 300° C. The higher temperature offgas is used to release the hydrogen from hydrogen storage system 56. The higher temperature offgas enables the use of a variety of metal hydride materials, some existing, some yet to be developed, having a reversible storage capacity greater than, for example, 7.5 wt % H₂.

Fuel cell 52 is typically a PEM fuel cell but can include a variety of other fuel cell types including but not limited to a phosphoric acid fuel cell, a solid oxide fuel cell or an alkali fuel cell. PEM fuel cells are typically associated with onboard or automotive applications, so many discussions within this application will focus on PEM fuel cells. While certain embodiments of this invention may primarily be discussed with reference to PEM fuel cells, this is not a limitation of this invention. An oxidant 62, typically air, and hydrogen (H₂), are introduced into fuel cell 52 and electrochemically react to produce electricity 63 and anode exhaust 58 comprising water (H₂O) and small quantities of unutilized H₂, for example less than about 15% by volume of the anode exhaust 58, and typically less than about 10% by volume. Oxidant 62 is introduced into fuel cell 52 through a flowpath 64. Alternatively, oxidant 62 can flow directly to catalytic combustor 54 along flowpath 66 when a valve 68 is opened. Typical H₂ utilization efficiency in a PEM fuel cell is less than about 90%, so there is some percentage of H₂ that cannot be converted inside the PEM fuel cell that is released via the anode exhaust 58. Anode exhaust 58 is typically so dilute in H₂, and contains such large quantities of steam, that homogeneous combustion cannot efficiently be utilized to recover heat from the anode exhaust 58 to take advantage of this otherwise wasted energy. Instead, the anode exhaust 58 is typically used directly, at its existing temperature, around 80° C., to heat the hydrogen storage system to release the hydrogen.

In the instant invention, however, anode exhaust 58 is directed into catalytic combustor 54. The anode exhaust 58 is catalytically reacted to produce an offgas 60 having an elevated temperature, for example greater than about 150° C. and typically greater than 300° C. In some embodiments of the invention, the temperature of the offgas 60 is between about 300° C. to about 900° C. In other embodiments of the invention, the temperature of the offgas 60 is between about 300° C. to about 500° C.

In catalytic combustor 54, oxidant 62, typically air, or part of the cathode exhaust 70 is mixed with the anode exhaust 58 at a predetermined ratio and is fed to a combustion catalyst such as Pt/Al₂O₃, Pt—Pd/Al₂O₃, Pt—Rh/Al₂O₃, Pt—Ru/Al₂O₃, or Pt—Ir/Al₂O₃, for example. Once the constituents begin to catalytically react, the small amount of H₂ in the anode exhaust 58 will react with the O₂ in the air or in the cathode exhaust 70 to generate heat. Depending on the H₂ concentration of the anode exhaust 58, and the ratio of air to H₂ or cathode exhaust 70 to anode exhaust 58 feeding into the catalytic combustor 54, the temperature of the catalyst (typically a catalyst bed), and correspondingly the temperature of the offgas 60, can be controlled over a wide temperature range, for example from about 150° C. to about 900° C.

Hydrogen storage system 56 is typically a metal hydride storage system. While certain embodiments of this invention will discuss hydrogen storage system 56 as a metal hydride storage tank, this is not a limitation of this invention. In fact any hydrogen storage system that requires temperatures greater than about 80° C. to release stored hydrogen to fuel cell system 50 is contemplated within this invention. Hydrogen storage system 56 is in heat transfer relationship with offgas 60 such that the heat from the offgas 60 can be used to release stored hydrogen within hydrogen storage system 56. As discussed above, because the temperature of offgas 60 is substantially higher than the temperature of the anode exhaust 58 exiting fuel cell 52, metal hydride materials, some existing, some yet to be developed, having a reversible storage capacity greater than, for example, 7.5 wt % H₂ can be used within hydrogen storage system 56. The metal hydride can be either a reversible hydride or a non-reversible hydride. An example of a reversible metal hydride is MgH₂ that has a reversible hydrogen storage capacity of 7.6 wt. %. MgH₂ requires about 300° C. temperature to absorb and release hydrogen. Such a hydride cannot be used in conventional fuel cell system 10, but can be used in the fuel cell systems of the instant invention. Another example of a reversible metal hydride storage material is a mixture of LiBH₄ and MgH₂ in a two to one ratio. The material has a demonstrated reversible hydrogen storage capacity of about 10 wt. %, but requires about 350-400° C. to absorb and release the hydrogen. Again, such a hydrogen storage material cannot be used in conventional fuel cell system 10, but can be used in the fuel cell systems of the current invention. One benefit of the increased temperature is that it allows new storage materials with higher absorption and adsorption temperatures to be considered for on-board storage solutions. One additional significant advantage of the increased temperature is faster kinetics that enables fast re-charge of H₂. Ideally one would like to re-charge the H₂ in less than 5 minutes, preferably less than 3 minutes. Many non-reversible high-capacity hydrides also require higher temperatures to release H₂. An example is LiBH₄ that can decompose to LiH and B and release about 13.8 wt. % H₂. The decomposition temperature is about 280° C. that is not feasible for conventional fuel cell system 10, but can be used in the fuel cell systems of the current invention.

In addition to the above-mentioned benefits of the instant invention, fuel cell system 50 provides the following additional advantages: the higher temperature offgas 60 can also be used to vary the pressure of the metal hydride storage tank making it unnecessary to use a blower to provide the released H₂ to the fuel cell 52; and an overall reduction in H₂ released to the atmosphere as the catalytic combustor 54 will reclaim most of the H₂ content of the anode exhaust 58. Hydrogen storage tank 56 typically has a pressure higher than one bar (one atmosphere pressure). The preferred pressure for PEM fuel cell operation is about 3 to about 10 bars. If the hydrogen pressure is less than one bar, an optional pump may be used to pump hydrogen from the storage tank 56 to the fuel cell 52 and to the catalytic combustor 54.

As discussed above, conventional fuel cell systems have difficulty starting in cold weather. To enable cold weather starts, at least one heater 72 is integrated with the catalytic combustor 54. In one embodiment, heater 72 is an electrical heater. In another embodiment, heater 72 is an ultrafast electric heater that heats up to about 300° C. in less than 5 seconds. For example, Emitec provides an electric-heated metal foil catalyst support system that could be utilized as heater 72. By applying a combustion catalyst, for example by wash-coating, on or near to the surface of the heater(s) 72, it is possible to heat the catalyst within catalytic combustor 54 to greater than 300° C. in a very short period of time, thereby activating the catalyst and preparing it for use. Typically, a battery 74 or other energy source provides the electrical current to energize heater 72. Hydrogen storage tank 56 is in flow communication with catalytic combustor 54 through a flowpath 76 and is in flow communication with fuel cell 52 through a flowpath 78. A valve 80 is disposed within flowpath 76 and a valve 82 is disposed within flowpath 78 to respectively control flows therethrough.

To enable cold start of fuel cell system 50, valve 68 and valve 80 are opened to provide both oxidant 62 along flowpath 66 and H₂ along flowpath 76 to catalytic combustor 54. In addition, heater 72 is energized to heat the catalyst within the catalytic combustor 54 to a temperature required for operation, for example greater than about 300 C. The catalytic combustion of the oxidant 62 and the H₂ will start to generate heat to release hydrogen from the hydrogen storage tank 56. Once sufficient quantities of H₂ are released from hydrogen storage tank 56 valves 68 and 80 are closed, heater 72 is shut down and valve 82 is opened and H₂ is directed to fuel cell 52 from hydrogen storage tank 56 and the fuel cell system 50 is fully operational and self supporting (as long as H₂ remains within hydrogen storage tank 56). The anode exhaust 58 and the oxidant 62 or cathode exhaust 70 can then sustain catalytic combustor 54 to provide the heat in offgas 60 for the continued desorption of hydrogen from the storage tank 56, as discussed in detail above. While not specifically shown or discussed in detail, a controller, microprocessor or other control system can be utilized to coordinate the opening or closing or valves or the energizing of heater 72, as well as any other control activity discussed herein.

Depending on the heat of desorption (ΔH) of the hydrogen storage material in storage tank 56 and the available residual hydrogen in the anode exhaust 58, valve 80 may optionally stay open or partially open and can be adjusted to provide additional hydrogen for the complete desorption of the hydrogen from the storage material. For instance, when 8% of residual hydrogen is available in the anode exhaust 58, catalytic combustion can produce about 19 kJ/mole of heat. If the heat of desorption (ΔH) of the hydrogen storage material is, for example, 35 kJ/mole of H₂, then about 7% of the hydrogen needs to be bled through valve 80 to completely release all hydrogen from the storage tank 56. Additionally, if the oxygen present within the cathode exhaust 70 is not enough to sustain the catalytic combustion process within catalytic combustor 54, valve 68 may optionally stay open or partially open and can be adjusted to provide additional oxidant 62 to catalytic combustor 54.

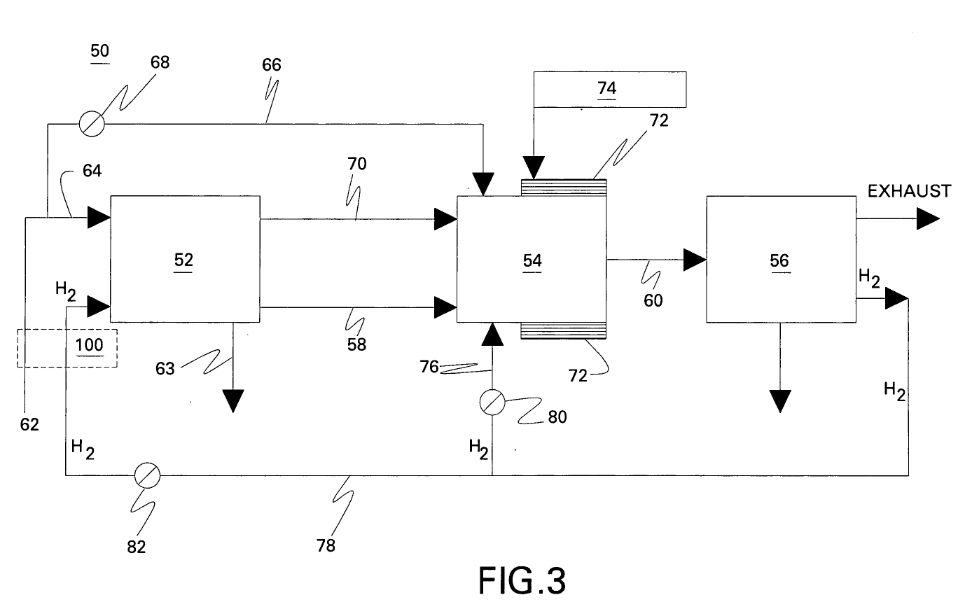

The hydrogen desorbed from the storage tank 56 is typically at a temperature that is greater than required for introduction into fuel cell 52, for example typically greater than 300° C. One embodiment of the current invention, as shown in FIG. 3, further comprises a regenerative heat exchanger 100. The regenerative heat exchanger 100 recovers the heat from the high temperature hydrogen gas coming out of the storage material, lowering the hydrogen temperature to a usable temperature by the fuel cell 52, and uses the withdrawn heat to create system efficiencies or releases it to the ambient. In one embodiment, the heat drawn out of the hydrogen is used to heat the oxidant 62 flowing into the fuel cell 52.

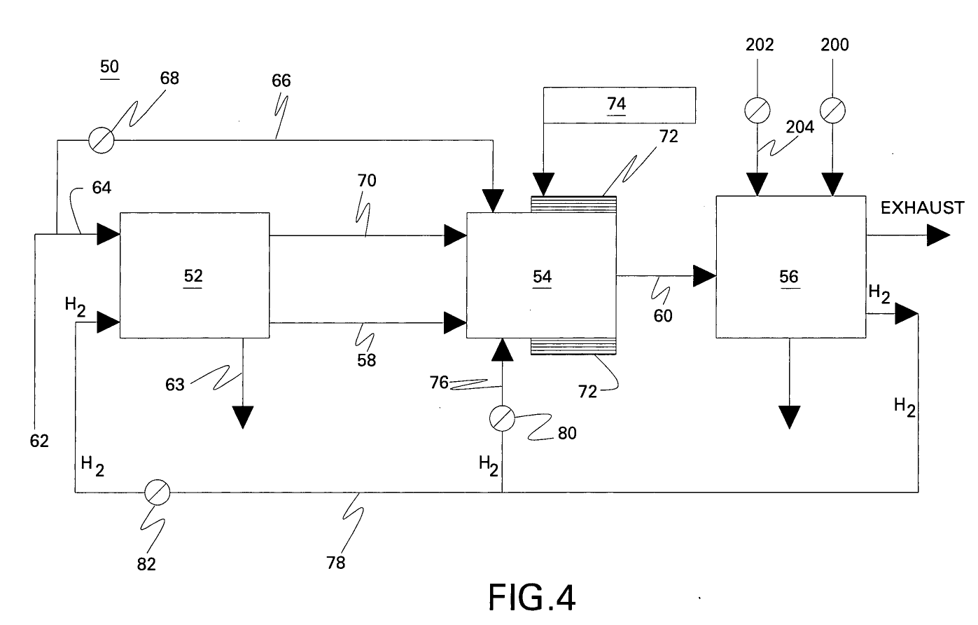

High capacity hydrogen storage material that desorbs hydrogen at a relatively high temperature usually also requires a high temperature to absorb hydrogen. Therefore, during re-charge of the hydrogen storage tank 56, the storage material should be maintained at a high temperature, for example greater than 300° C., as shown in FIG. 4. A hydrogen source 200, for example, a compressed hydrogen gas, is coupled with storage tank 56, for the introduction of hydrogen therein. In certain situations, the storage material of the storage tank 56 is cooled off from the operational temperature, for example, less than 300 C and occasionally will be completely cooled off to ambient temperature. In this situation, the hydrogen entering the storage tank 56 bypasses the storage tank and is directed along path 76 to the catalytic combustor 54 (valve 80 is open and valve 82 is closed). Oxidant 62 is provided to catalytic combustor 54 by opening valve 68. Battery 72 or another energy source provides electrical current to the electrical heater 72 to heat up the catalyst, and once the oxidant 62 and the hydrogen react with the heated combustion catalyst, the catalytic combustor 54 provides offgas 60 to storage tank 56 to heat up the storage material and enable the hydrogen absorption. Once the hydrogen absorption process begins, the heat generated by the absorption process itself can sustain the entire absorption process. Once, the heat generated by the process itself is sufficient, the valves 80 and 68 to catalytic combustor are shut off and the catalytic combustion process ends. Typically, the heat generated by the hydrogen absorption process is greater than the heat required to heat up the storage tank, thus a coolant 202, for example water, is supplied to storage tank 56 via flow path 204 to remove the excess heat from the system.

If fuel cell 52 is operating during hydrogen re-charge, the high temperature exhaust 60 from the catalytic combustor 54 is typically directed away from the hydrogen storage tank 56, to avoid overheating. In one embodiment, coolant 202 is introduced temporarily into storage tank 56 using the flowpaths that are typically used to carry the offgas 60 through the storage tank 56 during normal operations.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell system comprising:
a hydrogen storage system for storing and releasing hydrogen;
a fuel cell in fluid communication with said hydrogen storage system for receiving released hydrogen from said hydrogen storage system and for electrochemically reacting said hydrogen with an oxidant to produce electricity, a cathode exhaust and an anode exhaust;
a catalytic combustor in fluid communication with said fuel cell for receiving at least a portion of said anode exhaust and at least a portion of said cathode exhaust and for catalytically reacting said anode and said cathode exhausts to produce an offgas having an elevated temperature that is greater than the temperature of said anode exhaust or of said cathode exhaust.

2. A fuel cell system in accordance with claim 1, wherein said fuel cell is a PEM fuel cell.

3. A fuel cell system in accordance with claim 1, wherein said fuel cell is selected from the group consisting of a PEM fuel cell, a phosphoric acid fuel cell, and an alkali fuel cell.

4. A fuel cell system in accordance with claim 1, wherein said hydrogen storage system comprises a hydride material.

5. A fuel cell system in accordance with claim 4, wherein said hydride material comprises a reversible metal hydride material.

6. A fuel cell system in accordance with claim 1, wherein said cathode exhaust comprises greater than about 7 percent by volume of oxygen.

7. A fuel cell system in accordance with claim 1, wherein said cathode exhaust comprises between about 7 percent to about 11 percent by volume of oxygen.

8. A fuel cell system comprising:
a hydrogen storage system for storing and releasing hydrogen;
a fuel cell in fluid communication with said hydrogen storage system for receiving released hydrogen from said hydrogen storage system and for electrochemically reacting said hydrogen with an oxidant to produce electricity and an anode exhaust;
a catalytic combustor in fluid communication with said fuel cell for receiving at least a portion of said anode exhaust and for catalytically reacting said anode exhaust to produce an offgas having an elevated temperature that is greater than the temperature of said anode exhaust wherein heat from said offgas is used to release said hydrogen from said hydrogen storage system; and
at least one heater in a heat transfer relationship with said catalytic combustor to heat a catalyst within said catalytic combustor to initiate catalytic combustion.

9. A fuel cell system in accordance with claim 8, further comprising a battery to periodically energize said heater.

10. A fuel cell system in accordance with claim 8, further comprising a flowpath from said hydrogen storage system to said catalytic combustor for flowing hydrogen from said hydrogen storage system to said catalytic combustor for catalytic combustion and at least one valve disposed within said flowpath for controlling flow therethrough.

11. A fuel cell system in accordance with claim 10, further comprising a second flowpath to said catalytic combustor for flowing oxygen to said catalytic combustor for catalytic combustion with said hydrogen and at least one valve disposed within said second flowpath for controlling flow therethrough.

12. A fuel cell system in accordance with claim 8, wherein said at least one heater is an electrical heater.

13. A fuel cell system in accordance with claim 8, wherein said at least one heater is an electric heated metal foil catalyst support system.

14. A fuel cell system in accordance with claim 8, wherein said combustion catalyst is applied at our near the surface of said at least one heater.

15. A fuel cell system in accordance with claim 8, wherein said combustion catalyst is wash coated onto the surface of said at least one heater.

16. A fuel cell system in accordance with claim 10, wherein said first flowpath is maintained in at least a partially open position to provide supplemental hydrogen for introduction within said catalytic combustor.

17. A fuel cell system in accordance with claim 11, wherein said second flowpath is maintained in at least a partially open position to provide supplemental oxygen for introduction within said catalytic combustor.

18. A method of cold starting a fuel cell system comprising the steps of: directing a first flow of hydrogen and a first flow of oxidant to a catalytic combustor;
activating a heater that is in a thermal exchange relationship with said catalytic combustor to catalytically combust said hydrogen and said oxidant to produce an elevated temperature offgas;
directing said offgas to a hydrogen storage system to release hydrogen from said hydrogen storage system;
introducing said released hydrogen and a second flow of oxidant into a fuel cell to produce electricity, an anode exhaust and a cathode exhaust;
blocking the first flow of hydrogen and said first flow of oxidant; and
catalytically reacting said anode exhaust and said cathode exhaust in said catalytic combustor to produce an elevated temperature offgas to release the hydrogen for utilization within the fuel cell and generation of the anode exhaust and cathode exhaust for continued catalytic reactions.

19. A fuel cell system comprising:
a metal hydride hydrogen storage system for storing and releasing hydrogen, wherein said storage system has a reversible storage capacity of greater than about 3 weight percent;
a PEM fuel cell in fluid communication with said metal hydride storage system for receiving released hydrogen from said hydrogen storage system and for electrochemically reacting said hydrogen with an oxidant to produce electricity and an anode exhaust having a temperature of less than about 150 degrees Celsius;
a catalytic combustor in fluid communication with said PEM fuel cell for receiving at least a portion of said anode exhaust and for catalytically combusting said anode exhaust to produce an offgas having a temperature greater than about 150 degrees Celsius; and
at least one heater in a heat transfer relationship with said catalytic combustor to heat a catalyst within said catalytic combustor to initiate catalytic combustion.

20. A fuel cell system comprising:
a hydrogen storage system for storing and releasing hydrogen;
a fuel cell in fluid communication with said hydrogen storage system for receiving released hydrogen from said hydrogen storage system and for electrochemically reacting said hydrogen with an oxidant to produce electricity and an anode exhaust;
a catalytic combustor in fluid communication with said fuel cell for receiving at least a portion of said anode exhaust and for catalytically reacting said anode exhaust to produce an offgas having an elevated temperature that is greater than the temperature of said anode exhaust wherein heat from said offgas is used to release said hydrogen from said hydrogen storage system; and
at least one regenerative heat exchanger in flow communication with said hydrogen storage system and said fuel cell for reducing the temperature of said released hydrogen to a suitable temperature prior to introduction within said fuel cell.

21. A fuel cell system in accordance with claim 18, wherein said suitable temperature is in the range between about 70 C to about 120 C.

22. A fuel cell system in accordance with claim 18, wherein said regenerative heat exchanger uses the withdrawn heat to create system efficiencies.

23. A fuel cell system in accordance with claim 18, wherein said regenerative heat exchanger uses the withdrawn heat from said released hydrogen to heat said oxidant.

24. A fuel cell system comprising:
a rechargeable hydrogen storage system for storing and releasing hydrogen;
a fuel cell in fluid communication with said rechargeable hydrogen storage system for receiving released hydrogen from said rechargeable hydrogen storage system and for electrochemically reacting said hydrogen with an oxidant to produce electricity and an anode exhaust;
a catalytic combustor in fluid communication with said fuel cell for receiving at least a portion of said anode exhaust and for catalytically reacting said anode exhaust to produce an offgas having an elevated temperature that is greater than the temperature of said anode exhaust wherein heat from said offgas is used to release said hydrogen from said rechargeable hydrogen storage system; and
at least one heater in a heat transfer relationship with said catalytic combustor to heat a catalyst within said catalytic combustor to initiate catalytic combustion;
wherein during a recharging event, hydrogen from an external hydrogen source and said oxidant are directed to said catalytic combustor and said heater is energized and the hydrogen and oxidant are catalytically combusted to generate an elevated temperature offgas that heats said rechargeable hydrogen storage system to a suitable recharge temperature.
